(19) United States
(12) Patent Application Publication
(10) Pub. No.: US 2001/0006988 A1
(43) Pub. Date: Jul. 5, 2001

(54) Process for the preparation of polymers containing double bonds by ring-opening polymerization

(75) Inventors: Adolf Kuhnle, Marl (DE); Mark Duda, Ludwigshafen (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CREAVIS Gesellschaft fuer Technologie und Innovation mbH, Marl (DE)

(21) Appl. No.: 09/742,120

(22) Filed: Dec. 22, 2000

(30) Foreign Application Priority Data
Dec. 24, 1999 (DE) 199.63.125.5

(51) Int. Cl. C08K 5/52

(52) U.S. Cl. 524/127; 524/323; 524/430; 524/451; 526/113; 526/171; 526/172; 526/258; 526/282; 526/348.5

(57) ABSTRACT

A process for the preparation of polymers containing double bonds by ruthenium carbene catalysis is carried out, where a ring-opening polymerization of monomers of the Formula (I) occurs

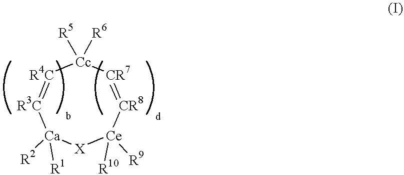

wherein R¹, R², R³, R⁴ R⁵, R⁶, R⁷ R⁸, R⁹ and R¹⁰ independently are H or a substituted or unsubstituted, aliphatic or aromatic hydrocarbon radical having 1 to 20 carbon atoms; X=O, S, NH or NR¹¹, where R¹¹ has one of the meanings of R¹; a, c end e=0, 1, 2 or 3, and b and d=0, 1 or 2; with the proviso that b and d are not simultaneously 0.

### BACKGROUND OF THE INVENTION

1. Field of the Invention

The invention relates to a process for the preparation of polymers containing double bonds by ruthenium carbene catalyzed ring-opening polymerization.

2. Discussion of the Background

Polymers containing double bonds are valuable raw materials since they can be further functionalized via the double bonds. They are often vulcanizable elastomers and are therefore suitable both for the preparation of high-quality elastomers and for the modification and upgrading of elastomers.

An example of a polymer containing double bonds is the polyoctenamer VESTENAMER®, which is prepared by metathetic polymerization of cyclooctene (“Industrielle Organische Chemie”, 1994, 98, VCH Verlagsgesellschaft mbH Weinheim).

Other polymers containing double bonds can be prepared, for example, by polymerization of dihydrofurans. Dihydrofurans are readily accessible industrially from maleic anhydride.

Although maleic anhydride, which can be prepared via natural gas (“Industrielle Organische Chemie”, 1994, 398-401, VCH Verlagsgesellschaft mbH Weinheim), can be converted into inexpensive dihydrofuran by hydrogenation, metathetic polymerization of dihydrofuran gives at best low-molecular-weight, oily polymers. The preparation of polydiallyl ethers has been described (JP 87-2993; C. T. Thu, T. Bastelberger, H. Hocker, Elsevier Sequoia 0304-5102/85). However, the polymers prepared by this process have low molecular weights and require very large amounts of catalyst. The catalysts used here were chromium carbenes, such as (CO)₅Cr═C(C₆H₅)₂ and (CO)₅Cr═C(OCH₃)C₆H₅, with a molar ratio between the ether and the carbene of 50:1, which corresponds to 50,000 ppm. These polydiallyl ethers are frequently colored, require large amounts of catalyst and need complex work-up, if this is possible at all. This work-up is at best appropriate in the low molecular weight ranges.

For ring-opening (ROMP) and ring-closing (RIM) polymerization of olefins, osmium or ruthenium complexes, as described, for example, in WO 98/21214, WO 98/30557 or WO 99/22865, have been employed. These catalysts are usually complexes of the general formula

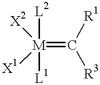

where R¹ and R² are substituted or unsubstituted hydrocarbon radicals, L¹ and L² are neutral electron donor ligands, such as phosphines, M═Rn or Os, and X¹ and X² are anionic ligands, such as halogens. The use of Schiff's bases as ligands has also been described in the literature. Catalyst systems of this type are particularly suitable for the metathetic polymerization of acyclic or cyclic olefins, such as, for example, cyclooctenes, norbornenes or hexenes, which may also be substituted. It is also possible to prepare crown ethers, i.e. oligomers. The polymerization of cyclic ethers to unsaturated polymers is not described. In addition, these processes use relatively large amounts of added acids, which is disadvantageous on a large scale in metal tanks due to corrosion problems.

Catalyst systems comparable to the above are also described in Angew. Chem. 1998, 110, No. 18 (2631-2633) and Journal of Organometallic Chemistry 582 (1999) 362-365. However, only the polymerization of various norbornene derivatives (for example aldehyde, alcohol, ketone, carboxylic acid and carboxylic acid ester) is mentioned here.

### SUMMARY OF THE INVENTION

One object of the present invention is to prepare polymers containing double bonds with a pale inherent color by ROMP. The amounts of catalyst employed should be sufficiently low so that the spent catalyst can remain directly in the product, meaning that further work-up steps are unnecessary. It is another object for the monomers to be prepared from sources which are available on a large industrial scale, such as, for example, from natural gas or C₄ fractions.

These and other objects are achieved according to the invention, the first embodiment of which includes a process for the preparation of polymers containing a double bond, comprising:

polymerizing at least one monomer of Formula (I)

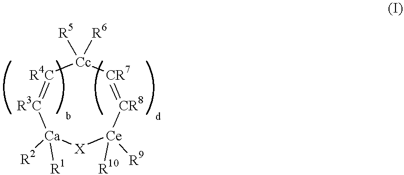

in the presence of a ruthenium carbene catalyst under ring-opening;

wherein

R¹, R², R³, R⁴ R⁵, R⁶, R⁷ R⁸, R⁹ and R¹⁰ independently are H or a substituted or unsubstituted, aliphatic or aromatic hydrocarbon radical having 1 to 20 carbon atoms;

X is O, S, NH or NR¹¹, wherein R¹¹ is H or a substituted or unsubstituted, aliphatic or aromatic hydrocarbon radical having 1 to 20 carbon atoms;

a, c and e are independently 0, 1, 2 or 3; and

b and d are independently 0, 1 or 2;

with the proviso that b and d are not simultaneously 0.

Another embodiment of the invention includes a polymer containing a double bond, prepared by the above process.

### DETAILED DESCRIPTION OF THE INVENTION

The process according to the invention can be carried out, for example, with 2,3-dihydrofuran as the monomer of Formula (I). The reaction then takes place in accordance with the following equation:

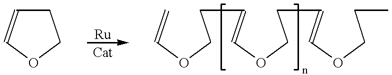

The monomer of the Formula (I) can be a ring system having at least three carbon atoms and a heteroatom, preferably a five-membered ring system having one to two C—C double bonds, particularly preferably substituted or unsubstituted furans or dihydrofurans, pyrroles or dihydropyrroles, thiophenes or dihydrothiophenes.

It is furthermore possible to use N-substituted pyrroles or dihydropyrroles. The substitute R¹¹ on the N atom in Formula (I) can be, in these embodiments of the invention, an aliphatic or aromatic hydrocarbon radical having 1 to 20 carbon atoms as defined for R¹, such as, for example, a methyl or t-butyl group.

Examples of monomers which can be used in the process according to the invention are, for example, 2,3-dihydrofuran, 2-hydroxymethyl-3,4-dihydro-2H-pyran, 5,6-dihydro-2H-pyran-2-one, 5,6-dihydro-4-methoxy-2H-pyran, furan, furan-3-carbaldehyde, furan-2-carboxylic acid, furfural, furfuryl alcohol, 2,5-dihydrofuran, 2,3-dihydrofuran, 2,3-dihydro-5-methylfuran, pyrrole-2-carboxylic acid, pyrrole-2-carbaldehyde, thiophene, thiophene-3-carbaldehyde and thiophene-2-carboxylic acid.

The substituents on the monomers of Formula (I) can also contain heteroatoms, such as O, S or N, for example in the form of aldehydes, carboxyl functions or alcohol groups.

In a further embodiment of the invention, the polymers containing double bonds are prepared by copolymerization of monomers of formula I with at least one further olefinically unsaturated monomer.

The further olefinically unsaturated monomer can be a cyclic compound having at least one endocyclic—optionally at least one exocyclic—double bond. Suitable here are all monocyclic, bicyclic or tricyclic ring systems containing double bonds, such as, for example, cyclopentene, cycloheptene, cyclooctene, cyclododecene, 1,4-hexediene, norbornene, dicyclopentadiene and 5-ethylidene-2-norbornene. These compounds can of course be copolymerized with further cyclic alkenes, enabling the corresponding terpolymers to be prepared. Taking into account the high thermodynamic stability of six-membered ring systems, even cyclohexene can be subjected to ring-opening copolymerization at low temperatures, preferably below 0° C.

It is furthermore possible to react a number of different monomers of the formula I in a copolymerization in accordance with the invention, i.e. substituted or unsubstituted furans, dihydrofurans, pyrroles, dihydropyrroles, thiophenes or dihydrothiophenes can be employed as the further olefinically unsaturated monomer.

However, acyclic compounds, such as ethene, propene, butadiene, n- and isobutene, pentene, hexene or C₈-olefins, can also be employed as the further olefinically unsaturated monomer in the process according to the invention.

The polymers or copolymers of monomers of Formula (I) containing double bonds and additional olefinically unsaturated monomers can comprise from 1 to 99% by weight, preferably from 10 to 90% by weight, particularly preferably from 50 to 90% by weight, of the monomers of Formula (I). The amount of additional olefinically unsaturated monomers includes all values therebetween especially including 5, 10, 15, 20, 25, 30, 35, 40, 45, 50, 55, 60, 65, 70, 75, 80 and 85% by weight based on the total weight of the polymer or copolymer.

The catalysts employed in the process according to the invention are preferably based on ruthenium to which a carbene, an alkylcarbene or an arylcarbene is bonded:

Ru═CH₂, . . . Ru═CH-alkyl, . . . Ru═CH-aryl

Further ruthenium ligands are one or two anions A:

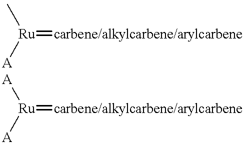

These anions A can be fluorine atoms, chlorine atoms, bromine atoms, iodine atoms, an acetate group or a trifluoroacetate group.

In addition, a leaving group B such as, for example, a tricyclohexylphosphine, a heterocyclic system containing double bonds, which can also function as electron donor C, or a transition-metal complex bridged via at least two halogen atoms, may be bonded to the ruthenium atom:

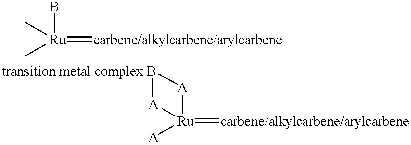

The electron donor C can be, for example, a heterocyclic system containing at least one double bond:

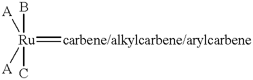

The following ruthenium carbene catalysts, for example, are suitable for the process according to the invention:

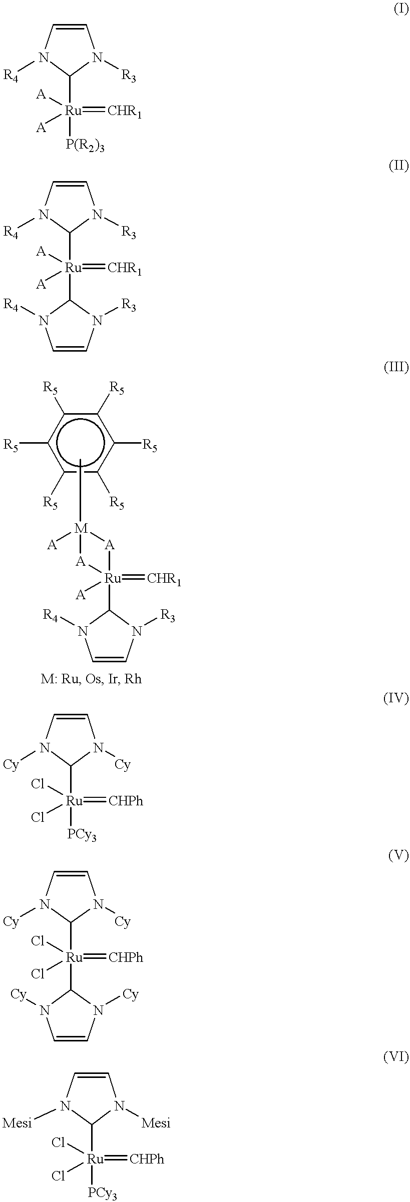

where Cy=a cyclohexyl radical, Ph=a phenyl radical and Mesi=a mesityl radical, R₁, R₂, R₃, R₄ and R₅ are independently H or a substituted or unsubstituted, aliphatic or aromatic hydrocarbon radical having 1-20 carbon atoms.

The polymers prepared in accordance with the invention can be provided with a multiplicity of additives. Preferred additives are, for example, heat and light stabilizers based on sterically hindered phenols, phosphites and so-called HALS stabilizers. More preferred additives are, for example, flame retardants, such as antimony trioxide and brominated phenyl ethers, and flame retardants based on aluminum hydroxide. Further preferred additives are fillers, such as carbon black, talc, chalks or ground limestone, plasticizers, lubricants, wetting agents, blowing agents, antistatics, fungicides, optical brighteners and UV absorbers.

The polymers prepared in accordance with the invention can be crosslinked either by means of divalent or polyvalent atoms, such as, for example, oxygen, sulfur, etc., or by irradiation, such as, for example, electron irradiation or irradiation with UV light.

The process according to the invention, i.e. the ring-opening polymerization of the monomers of Formula (I), can be carried out without a solvent, i.e. in the monomer or in a monomer mixture, or in a solvent, preferably in an aprotic solvent, such as THF, hexane and the like. The molecular weight Mₙ of the polymers, determined by osmometry, is generally greater than 40,000 g/mol. However, significantly higher molecular weights Mn, such as from 50,000 to 250,000 or from 50,000 to 100,000 g/mol, can also be prepared. The molecular weight Mn includes all values and subvalues therebetween, especially including 45,000; 50,000; 60,000; 70,000; 80,000; 90,000; 100,000; 120,000; 140,000; 160,000; 180,000; 200,000; 220,000 and 240,000 g/mol.

The polymerization itself can be carried out by intimately stirring the monomers together with the catalyst, if necessary with warming of the reaction mixture. Typical procedures are well known to the person skilled in the art or are given in the examples. Preferably, less than 1000 ppm, particularly preferably 500-1000 ppm, very particularly preferably less than 500 ppm, of ruthenium carbene catalyst, based on the sum of the monomers, are employed in the process according to the invention. The amount of ruthenium carbene catalyst includes all values and subvalues therebetween, especially including less than 100, 200, 300, 400, 500, 600, 700, 800 and less than 900 ppm.

The rapid course of the reaction in the process according to the invention due to the catalyst systems used is advantageous. The polymers prepared by the process according to the invention can be used as impact modifiers in plastics, as lubricant additives, as adhesives, as sealants, as additives for air-drying coating systems, as coating agents for fillers and as adhesion promoters and crosslinking auxiliaries in plastics.

The molecular weight and its abbreviation are defined as follows in accordance with the relevant DIN/ISO standards:

The term Mn used in the examples (or alternatively the osmometric molecular weight) is the number average molecular weight in g/mol. It is the quotient of the sample weight m in g and the amount of substance n in mol. The amount of substance can be measured, for example, by osmosis. However, Mn can also be determined from intersections of the distribution curve in gel permeation chromatography.

The melting point was determined via the DSC diagram, and the glass transition temperature T_{g} was determined in accordance with DIN 53 445.

Having generally described this invention, a further understanding can be obtained by reference to certain specific examples which are provided herein for purposes of illustration only, and are not intended to be limiting unless otherwise specified. As catalyst in the comparative examples, [RuCl₂(P(C₆H₂₂)₃)₂)] (catalyst VII) was used, as described in Angew. Chem. 1995, 107, 2179-2181 by R. H. Grubbs et al.

### EXAMPLES

### Example 1

### Comparative Example

100 g of 2,3-dihydrofuran were reacted with 10 mg of catalyst VII at room temperature in a 250 ml three-necked flask (without using solvents) with stirring and with exclusion of air. After 12 hours, a viscous product having the following properties was obtained:

Mn: 18,650

Glass transition temperature T_{g}: −62° C.

Melting point: cannot be measured

Color of the product: brown

### Example 2

### (According to the Invention)

100 g of 2,3-dihydrofuran were reacted with 10 mg of catalyst IV at room temperature in a 250 ml three-necked flask (without using solvents) with stirring and with exclusion of air. After 2 hours, an amorphous, solid polymer having the following properties was obtained:

Mn: 278,000

Glass transition temperature T_{g}: −76° C.

Melting point: about 48° C.

Color of the product: virtually white

### Example 3

### (According to the Invention)

100 g of 2,3-dihydrofuran were reacted with 10 mg of catalyst V at room temperature in a 250 ml three-necked flask (without using solvents) with stirring and with exclusion of air. After 4 hours, an amorphous, solid polymer having the following properties was obtained:

Mn: 339,000

Glass transition temperature T_{g}: −60° C.

Melting point: about 52° C.

Color of the product: yellowish white

### Example 4

### (According to the Invention)

100 g of 2,3-dihydrofuran were reacted with 10 mg of catalyst VI at room temperature in a 250 ml three-necked flask (without using solvents) with stirring and with exclusion of air. After 1 hour, an amorphous, solid polymer having the following properties was obtained:

Mn: 126,750

Glass transition temperature T_{g}: −56° C.

Melting point: about 43° C.

Color of the product: white

### Example 5

### (According to the Invention)

90 g of 2,3-dihydrofuran mixed with 10 g of norbornene were reacted with 10 mg of catalyst IV at a temperature of 35° C. in a 250 ml three-necked flask (without using solvents) with stirring and with exclusion of air. After 4 hours, an amorphous, solid polymer having the following properties was obtained:

Mn: 42,550

Glass transition temperature T_{g}: −91° C.

Melting point: about 33° C.

Color of the product: yellowish white

### Example 6

### (According to the Invention)

90 g of 2,3-dihydrofuran mixed with 10 g of norbornene were reacted with 10 mg of catalyst V at a temperature of 35° C. in a 250 ml three-necked flask (without using solvents) with stirring and with exclusion of air. After 4 hours, an amorphous, solid polymer having the following properties was obtained:

Mn: 56,850

Glass transition temperature T_{g}: −84° C.

Melting point: about 39° C.

Color of the product: yellowish white

### Example 7

### (According to the Invention)

90 g of 2,3-dihydrofuran mixed with 10 g of norbornene were reacted with 10 mg of catalyst VI at a temperature of 35° C. in a 250 ml three-necked flask (without using solvents) with stirring and with exclusion of air. After 1 hour, an amorphous, solid polymer having the following properties was obtained:

Mn: 43,650

Glass transition temperature T_{g}: −61° C.

Melting point: about 44° C.

Color of the product: white

### Example 8

### (According to the Invention)

90 g of 2,3-dihydrofuran mixed with 10 g of cyclooctene were reacted with 10 mg of catalyst IV at a temperature of 35° C. in a 250 ml three-necked flask (without using solvents) with stirring and with exclusion of air. After 3 hours, an amorphous, solid polymer having the following properties was obtained:

Mn: 43,300

Glass transition temperature T_{g}: −67° C.

Melting point: about 32° C.

Color of the product: yellowish white

### Example 9

### (According to the Invention)

90 g of 2,3-dihydrofuran mixed with 10 g of cyclooctene were reacted with 10 mg of catalyst V at a temperature of 35° C. in a 250 ml three-necked flask (without using solvents) with stirring and with exclusion of air. After 4 hours, an amorphous, solid polymer having the following properties was obtained:

Mn: 45,650

Glass transition temperature T_{g}: −60° C.

Melting point: about 37° C.

Color of the product: yellowish white

### Example 10

### (According to the Invention)

90 g of 2,3-dihydrofuran mixed with 10 g of cyclooctene were reacted with 10 mg of catalyst VI at a temperature of 35° C. in a 250 ml three-necked flask (without using solvents) with stirring and with exclusion of air. After 2 hours, an amorphous, solid polymer having the following properties was obtained:

Mn: 41,150

Glass transition temperature T_{g}: −67° C.

Melting point: about 35° C.

Color of the product: yellowish white

### Example 11

### (Comparative Example)

100 g of 2,3-dihydrofuran were reacted with 10 mg of catalyst VII in 250 ml of n-hexane at room temperature in a 500 ml three-necked flask with stirring and with exclusion of air. After 12 hours and after removal of the n-hexane by distillation, a viscous product having the following properties was obtained:

Mn: 24,300

Glass transition temperature T_{g}: −61° C.

Melting point: cannot be measured

Color of the product: pale brown

### Example 12

### (According to the Invention)

100 g of 2,3-dihydrofuran were reacted with 10 mg of catalyst IV in 250 ml of n-hexane at room temperature in a 500 ml three-necked flask with stirring and with exclusion of air. After 1 hour and after removal of the n-hexane by distillation, an amorphous, solid polymer having the following properties was obtained:

Mn: 125,000

Glass transition temperature T_{g}: −75° C.

Melting point: about 41° C.

Color of the product: white

### Example 13

### (Comparative Example)

100 g of cyclooctene were reacted with 10 mg of catalyst VII in 250 ml of n-hexane at room temperature in a 500 ml three-necked flask with stirring and with exclusion of air. After 12 hours and after removal of the n-hexane by distillation, a viscous product having the following properties was obtained:

Mn: 14,200

Glass transition temperature T_{g}: −63° C.

Melting point: cannot be measured

Color of the product: pale yellow

### Example 14

### (Comparative Example)

100 g of cyclooctene were reacted with 10 mg of catalyst VII in 250 ml of n-hexane at room temperature in a 500 ml three-necked flask with stirring and with exclusion of air. After 3.5 hours and after removal of the n-hexane by distillation, an amorphous, solid polymer having the following properties was obtained:

Mn: 56,400

Glass transition temperature T_{g}: −63° C.

Melting point: about 48° C.

Color of the product: white

The priority document of the present application, German patent application 199 63 125.5 filed Dec. 24, 1999, is incorporated herein by reference.

Obviously, numerous modifications and variations on the present invention are possible in light of the above teachings. It is therefore to be understood that within the scope of the appended claims, the invention may be practiced otherwise than as specifically described herein.

1. A process for the preparation of a polymer containing a double bond, comprising:
polymerizing at least one monomer of Formula (I) 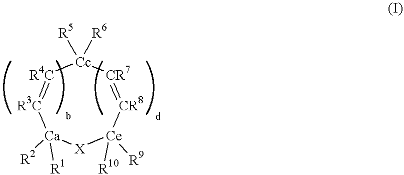
in the presence of a ruthenium carbene catalyst under ring-opening;
wherein
R¹, R², R³, R⁴ R⁵, R⁶, R⁷ R⁸, R⁹ and R¹⁰ independently are H or a substituted or unsubstituted, aliphatic or aromatic hydrocarbon radical having 1 to 20 carbon atoms;
X is O, S, NH or NR¹¹, wherein R¹¹ is H or a substituted or unsubstituted, aliphatic or aromatic hydrocarbon radical having 1 to 20 carbon atoms;
a, c and e are independently 0, 1, 2 or 3; and
b and d are independently 0, 1 or 2;
with the proviso that b and d are not simultaneously 0.

2. The process according to claim 1, wherein said monomer of Formula (I) is selected from the group consisting of a substituted furan, a substituted dihydrofuran, a substituted pyrrole, a substituted dihydropyrrole, a substituted thiophene, a substituted dihydrothiophene, an unsubstituted furan, an unsubstituted dihydrofuran, an unsubstituted pyrrole, an unsubstituted dihydropyrrole, an unsubstituted thiophene, an unsubstituted dihydrothiophene and mixtures thereof.

3. The process according to claim 1, wherein said monomer of Formula (I) is selected from the group consisting of 2,3-dihydrofuran, 2-hydroxymethyl-3,4-dihydro-2H-pyran, 5,6-dihydro-2H-pyran-2-one, 5,6-dihydro-4-methoxy-2H-pyran, furan, furan-3-carbaldehyde, furan-2-carboxylic acid, furfural, furfuryl alcohol, 2,5-dihydrofuran, 2,3-dihydrofuran, 2,3-dihydro-5-methylfuran, pyrrole-2-carboxylic acid, pyrrole-2-carbaldehyde, thiophene, thiophene-3 -carbaldehyde, thiophene-2-carboxylic acid and mixtures thereof.

4. The process according to claim 1, wherein said polymerizing is carried out with at least one additional olefinically unsaturated monomer.

5. The process according to claim 4, wherein said additional olefinically unsaturated monomer is a cyclic compound having at least one endocyclic double bond and optionally at least one exocyclic double bond.

6. The process according to claim 5, wherein said cyclic compound is selected from the group consisting of a monocyclic, a bicyclic and a tricyclic ring system.

7. The process according to claim 5, wherein said cyclic compound is cyclopentene, cyclohexane, cycloheptene, cyclooctene, cyclododecene, 1,4-hexediene, norbornene, dicyclopentadiene and 5-ethylidene-2-norbornene.

8. The process according to claim 4, wherein said additional olefinically unsaturated monomer is an acyclic compound.

9. The process according to claim 8, wherein said acyclic compound is ethene, propene, butadiene, n- and isobutene, pentene, hexene or a C₈-olefin.

10. The process according to claim 4, wherein said additional olefinically unsaturated monomer is selected from the group consisting of a substituted furan, a substituted dihydrofuran, a substituted pyrrole, a substituted dihydropyrrole, a substituted thiophene, a substituted dihydrothiophene, an unsubstituted furan, an unsubstituted dihydrofuran, an unsubstituted pyrrole, an unsubstituted dihydropyrrole, an unsubstituted thiophene, an unsubstituted dihydrothiophene and mixtures thereof.

11. The process according to claim 1, wherein said polymer containing a double bond comprises from 1 to 99% by weight of said monomer of Formula (I) based on the total weight of said polymer.

12. The process according to claim 1, wherein said polymer containing a double bond comprises from 10 to 90% by weight of said monomer of Formula (I) based on the total weight of said polymer.

13. The process according to claim 1, wherein said polymer containing a double bond comprises from 50 to 90% by weight of said monomer of Formula (I) based on the total weight of said polymer.

14. The process according to claim 1, wherein said polymer containing a double bond has a molecular weight Mₙ of from 50,000 to 250,000 g/mol.

15. The process according to claim 1, wherein said polymer containing a double bond has a molecular weight Mₙ of from 50,000 to 100,000 g/mol.

16. The process according to claim 1, wherein said polymer containing a double bond has a molecular weight Mₙ of greater than 40,000 g/mol.

17. The process according to claim 1, further comprising crosslinking of said polymer by electron irradiation or UV irradiation, thereby providing a crosslinked polymer.

18. The process according to claim 1, wherein said polymerizing is carried out without solvents.

19. The process according to claim 1, wherein said polymerizing is carried out in a solvent.

20. The process according to claim 19, wherein said solvent is an aproptic solvent.

21. The process according to claim 1, further comprising adding an additive.

22. The process according to claim 23, wherein said additive is selected from the group consisting of a heat stabilizer, a light stabilizer, a flame retardant, a plasticizer, a lubricant, a wetting agent, a blowing agent, an antistatic, a fungicide, an optical brightener, a UV absorber, and mixtures thereof.

23. The process according to claim 22, wherein said light stabilizer is selected from the group consisting of a sterically hindered phenol, a phosphite, a HALS stabilizer and mixtures thereof.

24. The process according to claim 22, wherein said flame retardant is selected from the group consisting of antimony trioxide, a brominated phenyl ether, an aluminum hydroxide and mixtures thereof.

25. The process according to claim 22, wherein said filler is selected from the group consisting of carbon black, talc, chalk, ground limestone and mixtures thereof.

26. The process according to claim 4, wherein an amount of said ruthenium carbene catalyst is less than 1000 ppm based on the amount of said monomer of Formula (I) and said additional olefinically unsaturated monomer.

27. The process according to claim 4, wherein an amount of said ruthenium carbene catalyst is 500 to 1000 ppm, based on the amount of said monomer of Formula (I) and said additional olefinically unsaturated monomer.

28. The process according to claim 4, wherein an amount of said ruthenium carbene catalyst is less than 500 ppm, based on the amount of said monomer of Formula (I) and said additional olefinically unsaturated monomer.

29. The process according to claim 1, wherein said ruthenium carbene catalyst comprises ruthenium bonded to a carbene, an alkylcarbene or an arylcarbene.

30. The process according to claim 29, wherein said ruthenium carbene catalyst further comprises a anion bonded to ruthenium selected from fluorine, chlorine, bromine, iodine, and an acetate group or a trifluoracetate group.

31. The process according to claim 29, wherein said ruthenium carbene catalyst further comprises a leaving group a tricyclohexylphosphine or a heterocyclic system containing a double bond.

32. The process according to claim 1, wherein the ruthenium carbene catalyst employed is a compound of Formula (I), Formula (II), Formula (III), Formula (IV), Formula (V) or Formula (VI) 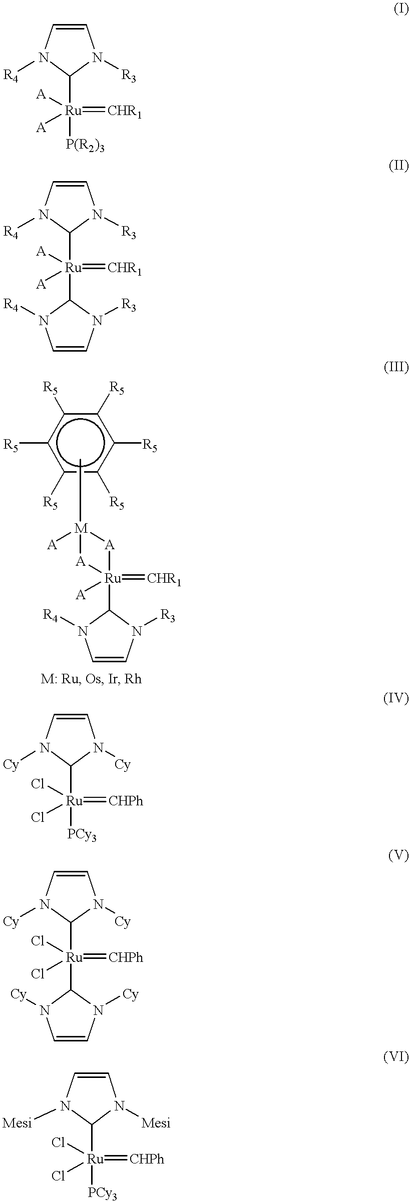
wherein
Cy=a cyclohexyl radical;
Ph=a phenyl radical;
Mesi=a mesityl radical; and
R₁, R₂, R₃, R₄ and R₅ are independently H or a substituted or unsubstituted, aliphatic or aromatic hydrocarbon radical having 1-20 carbon atoms.

33. A polymer containing a double bond, prepared by a process, comprising:
polymerizing at least one monomer of Formula (I) 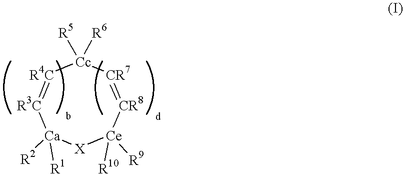
in the presence of a ruthenium carbene catalyst under ring-opening;
wherein
R¹, R², R³, R⁴ R⁵, R⁶, R⁷ R⁸, R⁹ and R¹⁰ independently are H or a substituted or unsubstituted, aliphatic or aromatic hydrocarbon radical having 1 to 20 carbon atoms;
X is O, S, NH or NR¹¹, wherein R¹¹ is H or a substituted or unsubstituted, aliphatic or aromatic hydrocarbon radical having 1 to 20 carbon atoms;
a, c and e are independently 0, 1, 2 or 3; and
b and d are independently 0, 1 or 2;
with the proviso that b and d are not simultaneously 0.

34. The polymer according to claim 33, wherein said monomer of Formula (I) is selected from the group consisting of a substituted furan, a substituted dihydrofuran, a substituted pyrrole, a substituted dihydropyrrole, a substituted thiophene, a substituted dihydrothiophene, an unsubstituted furan, an unsubstituted dihydrofuran, an unsubstituted pyrrole, an unsubstituted dihydropyrrole, an unsubstituted thiophene, an unsubstituted dihydrothiophene and mixtures thereof.

35. The polymer according to claim 33, wherein said monomer of Formula (I) is selected from the group consisting of 2,3-dihydrofuran, 2-hydroxymethyl-3,4-dihydro-2H-pyran, 5,6-dihydro-2H-pyran-2-one, 5,6-dihydro-4-methoxy-2H-pyran, furan, furan-3-carbaldehyde, furan-2-carboxylic acid, furfural, furfuryl alcohol, 2,5-dihydrofuran, 2,3-dihydrofuran, 2,3-dihydro-5-methylfuran, pyrrole-2-carboxylic acid, pyrrole-2-carbaldehyde, thiophene, thiophene-3-carbaldehyde, thiophene-2-carboxylic acid and mixtures thereof.

36. The polymer according to claim 33, wherein said polymerizing is carried out with at least one additional olefinically unsaturated monomer.

37. The polymer according to claim 36, wherein said additional olefinically unsaturated monomer is a cyclic compound having at least one endocyclic double bond and optionally at least one exocyclic double bond.

38. The polymer according to claim 37, wherein said cyclic compound is selected from the group consisting of a monocyclic, a bicyclic and a tricyclic ring system.

39. The polymer according to claim 37, wherein said cyclic compound is cyclopentene, cyclohexane, cycloheptene, cyclooctene, cyclododecene, 1,4-hexediene, norbornene, dicyclopentadiene and 5-ethylidene-2-norbornene.

40. The polymer according to claim 36, wherein said additional olefinically unsaturated monomer is an acyclic compound.

41. The polymer according to claim 40, wherein said acyclic compound is ethene, propene, butadiene, n- and isobutene, pentene, hexene or a C₈-olefin.

42. The polymer according to claim 36, wherein said additional olefinically unsaturated monomer is selected from the group consisting of a substituted furan, a substituted dihydrofuran, a substituted pyrrole, a substituted dihydropyrrole, a substituted thiophene, a substituted dihydrothiophene, an unsubstituted furan, an unsubstituted dihydrofuran, an unsubstituted pyrrole, an unsubstituted dihydropyrrole, an unsubstituted thiophene, an unsubstituted dihydrothiophene and mixtures thereof.

43. The polymer according to claim 33, wherein said polymer containing a double bond comprises from 1 to 99% by weight of said monomer of Formula (I) based on the total weight of said polymer.

44. The polymer according to claim 33, wherein said polymer containing a double bond comprises from 10 to 90% by weight of said monomer of Formula (I) based on the total weight of said polymer.

45. The polymer according to claim 33, wherein said polymer containing a double bond comprises from 50 to 90% by weight of said monomer of Formula (I) based on the total weight of said polymer.

46. The polymer according to claim 33, wherein said polymer containing a double bond has a molecular weight Mₙ of from 50,000 to 250,000 g/mol.

47. The polymer according to claim 33, wherein said polymer containing a double bond has a molecular weight Mₙ of from 50,000 to 100,000 g/mol.

48. The polymer according to claim 33, wherein said polymer containing a double bond has a molecular weight Mₙ of greater than 40,000 g/mol.

49. The polymer according to claim 33, wherein said process further comprises crosslinking of said polymer by electron irradiation or UV irradiation, thereby providing a crosslinked polymer.

50. The polymer according to claim 33, wherein said polymer is crosslinked by divalent or polyvalent atoms.

51. The polymer according to claim 33, wherein said polymerizing is carried out without solvents.

52. The polymer according to claim 33, wherein said polymerizing is carried out in a solvent.

53. The polymer according to claim 52, wherein said solvent is an aproptic solvent.

54. The polymer according to claim 33, wherein said process further comprises adding an additive.

55. The polymer according to claim 54, wherein said additive is selected from the group consisting of a heat stabilizer, a light stabilizer, a flame retardant, a plasticizer, a lubricant, a wetting agent, a blowing agent, an antistatic, a fungicide, an optical brightener, a UV absorber, and mixtures thereof.

56. The polymer according to claim 55, wherein said light stabilizer is selected from the group consisting of a sterically hindered phenol, a phosphite, a HALS stabilizer and mixtures thereof.

57. The polymer according to claim 55, wherein said flame retardant is selected from the group consisting of antimony trioxide, a brominated phenyl ether, an aluminum hydroxide and mixtures thereof.

58. The polymer according to claim 55, wherein said filler is selected from the group consisting of carbon black, talc, chalk, ground limestone and mixtures thereof.

59. The polymer according to claim 36, wherein an amount of said ruthenium carbene catalyst is less than 1000 ppm based on the amount of said monomer of Formula (I) and said additional olefinically unsaturated monomer.

60. The polymer according to claim 36, wherein an amount of said ruthenium carbene catalyst is 500 to 1000 ppm, based on the amount of said monomer of Formula (I) and said additional olefinically unsaturated monomer.

61. The polymer according to claim 36, wherein an amount of said ruthenium carbene catalyst is less than 500 ppm, based on the amount of said monomer of Formula (I) and said additional olefinically unsaturated monomer.

62. The polymer according to claim 33, wherein said ruthenium carbene catalyst comprises ruthenium bonded to a carbene, an alkylcarbene or an arylcarbene.

63. The polymer according to claim 62, wherein said ruthenium carbene catalyst further comprises a anion bonded to ruthenium selected from fluorine, chlorine, bromine, iodine, and an acetate group or a trifluoracetate group.

64. The polymer according to claim 62, wherein said ruthenium carbene catalyst further comprises a leaving group a tricyclohexylphosphine or a heterocyclic system containing a double bond.

65. The polymer according to claim 33, wherein the ruthenium carbene catalyst employed is a compound of Formula (I), Formula (II), Formula (III), Formula (IV), Formula (V) or Formula (VI) 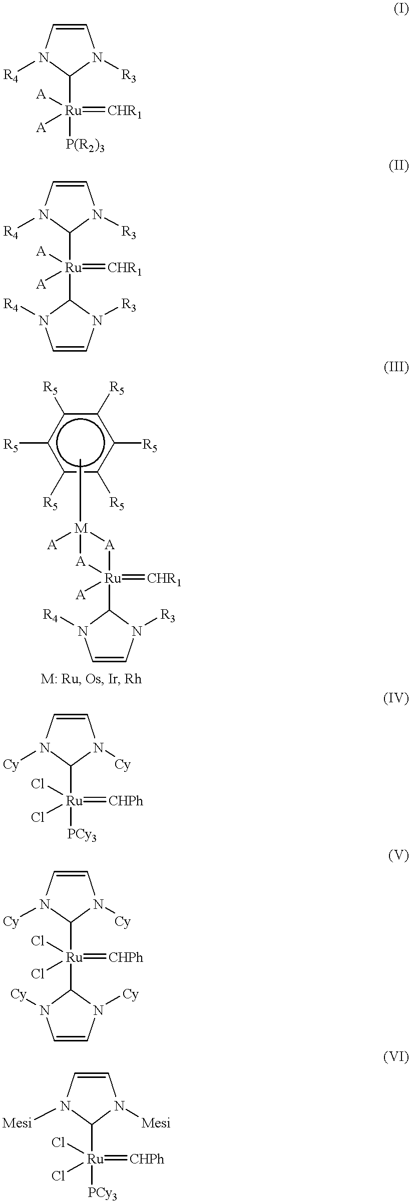
wherein
Cy=a cyclohexyl radical;
Ph=a phenyl radical;
Mesi=a mesityl radical; and
R₁, R₂, R₃, R₄ and R₅ are independently H or a substituted or unsubstituted, aliphatic or aromatic hydrocarbon radical having 1-20 carbon atoms.

66. An impact modifier for plastics, comprising:
the polymer according to claim 33.

67. A lubricant additive, comprising:
the polymer according to claim 33.

68. An adhesive, comprising:
the polymer according to claim 33.

69. A sealant, comprising:
the polymer according to claim 33.

70. An additive for an air-drying coating system, comprising:
the polymer according to claim 33.

71. A coating agent for a filler, comprising:
the polymer according to claim 33.

72. An adhesion promoter, comprising:
the polymer according to claim 33.

73. A crosslinking auxilliary in plastics, comprising:
the polymer according to claim 33.
